(19) United States
(12) Patent Application Publication
(10) Pub. No.: US 2026/0052150 A1
(43) Pub. Date: Feb. 19, 2026

(54) RESOURCE SHARING METHOD, APPARATUS, ELECTRONIC DEVICE AND STORAGE MEDIUM

(71) Applicant: Beijing Zitiao Network Technology Co., Ltd., Beijing (CN)

(72) Inventors: Ran CAI, Beijing (CN); Jie PAN, Beijing (CN); Jiabin ZHENG, Beijing (CN); Jian WANG, Beijing (CN)

(21) Appl. No.: 19/299,111

(22) Filed: Aug. 13, 2025

(30) Foreign Application Priority Data
Aug. 14, 2024 (CN) 202411112080.X

(51) Int. Cl. H04L 9/40

(52) U.S. Cl. CPC H04L 63/101; H04L 63/104

(57) ABSTRACT

The present disclosure provides a resource sharing method, an apparatus, an electronic device, and a storage medium. The resource sharing method includes: acquiring, in response to a first operation of a first user accessing a target resource and the first user having an access permission to the target resource, an identification of a first user, where the first user belongs to a first user group, and the target resource belongs to a second user group to which a second user belongs; and creating, in response to an identification list associated with the target resource not comprising the identification of the first user, a target type identification for the first user and adding the target type identification to the identification list.

### CROSS-REFERENCE TO RELATED APPLICATION

This application claims priority to Chinese Application No. 202411112080.X filed on Aug. 14, 2024, the disclosure of which is incorporated herein by reference in its entirety.

### FIELD

The present disclosure relates to the field of computer technology, and in particular, to a resource sharing method, an apparatus, an electronic device, and a storage medium.

### BACKGROUND

In a platform that shares resources, for example, a cloud computing platform or a software as a service platform, tenant isolation is usually adopted in consideration of data security, and users under one tenant usually is only able to access resources under the tenant.

### SUMMARY

The present disclosure provides a resource sharing method, an apparatus, an electronic device, and a storage medium.

The present disclosure adopts the following technical solutions.

In some embodiments, the present disclosure provides a resource sharing method, including:
acquiring, in response to a first operation of a first user accessing a target resource and the first user having an access permission to the target resource, an identification of the first user, where the first user belongs to a first user group, and the target resource belongs to a second user group to which a second user belongs; and
creating, in response to an identification list associated with the target resource not including the identification of the first user, a target type identification for the first user and adding the target type identification to the identification list;
where the identification list is used to record an identification of user who is able to access the target resource.

In some embodiments, the present disclosure provides a resource sharing apparatus, including:
an acquiring unit, configured to acquire, in response to a first operation of a first user accessing a target resource and the first user having an access permission to the target resource, an identification of a first user,
where the first user belongs to a first user group, and the target resource belongs to a second user group to which a second user belongs; and
a control unit, configured to create, in response to an identification list associated with the target resource not including the identification of the first user, a target type identification for the first user and add the target type identification to the identification list;
where the identification list is used to record an identification of user who is able to access the target resource.

In some embodiments, the present disclosure provides an electronic device, including: at least one memory and at least one processor;

where the memory is configured to store program codes, and the processor is configured to invoke the program codes stored in the memory to perform the above method.

In some embodiments, the present disclosure provides a computer-readable storage medium, where the computer-readable storage medium is used to store program codes, and the program codes, when executed by a processor, cause the processor to perform the above method.

### BRIEF DESCRIPTION OF THE DRAWINGS

The above and other features, advantages and aspects of various embodiments of the present disclosure will become more apparent when taken in conjunction with the drawings and with reference to the following detailed description. Throughout the drawings, the same or similar reference numerals refer to the same or similar elements. It should be understood that the drawings are schematic and that elements and components are not necessarily drawn to scale.

FIG. 1 is a flowchart of a resource sharing method according to an embodiment of the present disclosure.

FIG. 2 is an interaction diagram of a resource sharing method according to an embodiment of the present disclosure.

FIG. 3 is a schematic structural diagram of an electronic device according to an embodiment of the present disclosure.

### DETAILED DESCRIPTION OF EMBODIMENTS

It may be understood that before using the technical solutions disclosed in the embodiments of the present disclosure, users should be informed of the type, usage scope, usage scenario, etc. of the personal information involved in the present disclosure in an appropriate manner according to relevant laws and regulations, and the authorization of the users should be obtained.

For example, in response to receiving an active request from a user, prompt information is sent to the user to explicitly prompt the user that the operation requested to be performed will require the acquisition and use of the user's personal information. In this way, the user can independently select whether to provide personal information to software or hardware such as an electronic device, an application, a server, or a storage medium that performs the operation of the technical solution of the present disclosure according to the prompt information.

As an optional but non-limiting implementation, the manner of sending prompt information to the user in response to receiving the active request from the user may be, for example, a pop-up window, and the prompt information may be presented in the pop-up window in the form of text. In addition, the pop-up window may also carry a selection control for the user to select “agree” or “disagree” to provide personal information to the electronic device.

It may be understood that the above process of notifying and obtaining user authorization is only illustrative, and does not constitute a limitation on the implementations of the present disclosure. Other manners that meet relevant laws and regulations may also be applied to the implementations of the present disclosure.

It may be understood that the data involved in the technical solution (including but not limited to the data itself, the acquisition or use of data) should comply with requirements of corresponding laws, regulations, and relevant provisions.

The embodiments of the present disclosure will be described in more detail below with reference to the drawings. Although some embodiments of the present disclosure are shown in the drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that the steps described in the method implementations of the present disclosure may be performed in sequence and/or in parallel. In addition, the method implementations may include additional steps and/or omit performing the illustrated steps. The scope of the present disclosure is not limited in this regard.

As used herein, the term “include/comprise” and its variants are open-ended inclusions, that is, “include/comprise but not limited to”. The term “based on” is “based at least in part on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that concepts such as “first” and “second” mentioned in the present disclosure are only used to distinguish different apparatuses, modules, or units, and are not used to limit the order or interdependence of the functions performed by these apparatuses, modules, or units.

It should be noted that the modification of “one” mentioned in the present disclosure is illustrative rather than restrictive, and those skilled in the art should understand that it should be understood as “one or more” unless the context clearly indicates otherwise.

The names of messages or information exchanged between multiple apparatuses in the implementations of the present disclosure are only for illustrative purposes, and are not intended to limit the scope of these messages or information.

The solutions provided by the embodiments of the present disclosure will be described in detail below with reference to the drawings.

In a platform that shares resources, tenant (also referred to as user group, which may usually be a company, conglomerate, community, etc., with users under the tenant) isolation is adopted, and users under different tenants is only able to access resources under their respective tenants. However, some resources naturally have a need to be shared externally, and need to support users outside the tenant to which they belong to access and use them. Therefore, the sharing platform needs to provide solutions for external sharing of these resources without breaking the limitation of tenant isolation.

In some related technologies, in order to realize resource sharing under the condition of tenant isolation, users under all upstream and downstream tenants will be added to a new tenant, and necessary resources in the original tenant will be synchronized to the new tenant to realize cross-tenant collaboration. This way requires separate tenant resources, and users need to switch their tenants to access resources, which causes inconvenience.

In other related technologies, the administrator authorizes users under different tenants to establish a mutual trust relationship, and users can use their identifications to access resources shared across tenants in a limited manner. This way requires administrator authorization, and when multiple tenants are involved, multiple authorizations are required.

In other related technologies, users under other tenants join a special tenant as visitors, and users under the special tenant can access resources of other tenants in a limited manner. This way requires users to switch their tenants to the special tenant to access resources under other tenants.

In other related technologies, the application program interface is modified, and a new access credential that explicitly marks the related tenant needs to be replaced to access resources across tenants. This way requires the interface to support the access credential of the related tenant.

In the method provided by the embodiment of the present disclosure, the first user can access the target resource through the target type identification without breaking user group isolation.

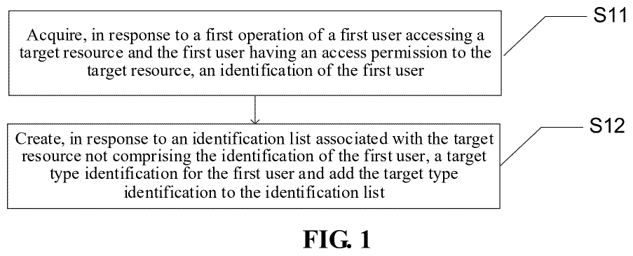

As shown in FIG. 1, FIG. 1 is a flowchart of a resource sharing method according to an embodiment of the present disclosure, including the following steps.

S11, an identification of a first user is acquired in response to a first operation of the first user accessing a target resource and the first user having an access permission to the target resource.

In some embodiments, the embodiments proposed in the present disclosure may be used for a resource sharing platform, such as a software as a service platform. The resource sharing platform usually adopts tenant (which may also be referred to as user group) isolation, and users under one user group is only able to access resources under the user group by using their identifications. The target resource may be an application. The first operation may be, for example, triggering a link of the target resource or scanning a quick response code of the target resource to attempt to access the target resource. In some embodiments, whether the first user is granted the access permission to the target resource may be determined according to the identification of the first user. The first user belongs to a first user group, and the target resource belongs to a second user group to which a second user belongs. In some embodiments, the first user is only able to access resources of the first user group through the identification of the first user, but cannot access resources of the second user group. The first user may be granted the access permission to the target resource by the second user. Specifically, the second user may grant the access permission to the target resource to the identification of the first user, but due to different user groups, the first user cannot directly access the target resource through the identification of the first user. The first user and the second user are users of different user groups.

S12, a target type identification for the first user is created and the target type identification is added to the identification list in response to the identification list associated with the target resource not including the identification of the first user.

In some embodiments of the present disclosure, the first user is granted the access permission to the target resource by the second user. The identification list is used to record an identification of user who is able to access the target resource. Users corresponding to identifications in the identification list may access the target resource by using their identifications in the identification list. In a case that the first user attempts to access the target resource, the identification list associated with the target resource may be acquired. Then it is determined whether the identification of the first user is located in the identification list. If the identification of the first user (the identification of the first user may characterize that the first user is in the first user group, and the identification of the first user may include the first user group to which the first user belongs and a code of the first user in the first user group) is not located in the identification list of the target resource, the identification of the first user is not added to the identification list, because the target resource is a resource of the second user group, and the identification of the first user in the first user group cannot be added, otherwise the user group isolation will be broken. Therefore, a target type identification is additionally created for the first user, and the target type identification is added to the identification list. The target type identification may be associated with the identification of the first user, so that the first user can access the target resource through the target type identification when accessing the target resource this time and when accessing the target resource subsequently.

In some embodiments of the present disclosure, in the case where the first user is granted the access permission to the target resource, since the target resource is a resource of the second user group, and is limited by the user group isolation, the target resource cannot be directly accessed through the identification of the first user. Therefore, the target type identification is created for the first user and added to the identification list of the target resource, so that the first user can access the target resource through the target type identification without breaking the user group isolation. Compared with related technologies, in this embodiment, when accessing the target resource, the first user does not need to switch the user group to which he/she belongs, does not need the application program interface to support the access credential, does not need the administrator to authorize multiple times, nor does he/she need to create a new user group to avoid the user group isolation.

In some embodiments of the present disclosure, the first user is only able to access resources of the first user group through the identification of the first user. The first user cannot directly access the target resource through the identification, because the target resource does not belong to the first user group. In order to realize resource sharing across user groups, in some embodiments of the present disclosure, the target type identification is created, so that the first user can access the target resource through the target type identification without breaking the user group isolation. In the embodiment of the present disclosure, in view of the situation of user group isolation, in order to share resources without breaking the user group isolation, the target type identification is additionally created for the first user, so that the first user can access the target resource through the target type identification instead of using the identification of the first user.

In some embodiments of the present disclosure, the target resource includes an application; and/or, the target resource is a resource created by the second user. In some embodiments, the target resource itself may be an application, which may be an application created by the second user on the resource sharing platform, and it may be defaulted that only users in the user group to which the second user belongs may access the application.

In some embodiments of the present disclosure, after creating the target type identification for the first user and adding the target type identification to the identification list, the method further includes: accessing the target resource through the target type identification. In some embodiments, after creating the target type identification for the first user, the target type identification may be automatically used as the identification of the first user to access the target resource. In other embodiments, the first user may be fed back first, for example, a message is sent to inform that the target type identification has been created for the first user, and then the target type identification is used to access the target resource after the first user performs a specific operation (for example, refreshing). Because in some cases, after the target type identification is created, some processing may need to be performed, which takes time. Therefore, the target resource is accessed after the first user performs the specific operation, so as to ensure that the first user is still online.

In some embodiments of the present disclosure, accessing the target resource through the target type identification includes: determining the first user's permission for a target content in the target resource in response to the first user accessing the target content; and determining whether to display the target content for the first user based on whether the first user has an access permission to the target content.

In some embodiments, having the access permission to the target resource is not equivalent to having the access permission to all contents in the target resource. In this embodiment, the authority management is refined to the content in the target resource. On the basis of having the access permission to the target resource, the first user may also need the access permission to the content if he/she wants to access the content in the target resource. Therefore, when the first user accesses the target content in the target resource, it is also necessary to determine that he/she has the access permission to the target content, and the target content is displayed or corresponding processing is performed only when he/she has the access permission to the target content, thereby improving the precision of authority management.

In some embodiments of the present disclosure, the target type identification is mapped to an identification of the second user and a resource identification of the target resource respectively. In some embodiments, when or after creating the target type identification, the target type identification may be established in the mapping relationship with the identification of the second user, so that it can be known who grants the first user the access permission to the target resource. The target type identification is established in the mapping relationship with the resource identification of the target resource, so that it can be known, through the target type identification, what resource needs to adapt to the target type identification when being accessed, so that the target type identification can be used when accessing the target resource.

In some embodiments of the present disclosure, before acquiring, in response to the first operation of the first user accessing the target resource, the identification of the first user, the method further includes: granting the first user the access permission to the target resource in response to a second operation of the second user; and sharing the target resource with the first user in response to a third operation on the target resource. In some embodiments, the second operation may be, for example, an authority application operation, and the second user may apply for the access permission to the target resource for the first user. The third operation may be a sharing operation, and after the access permission is applied, the second user or other users may share the target resource with the first user.

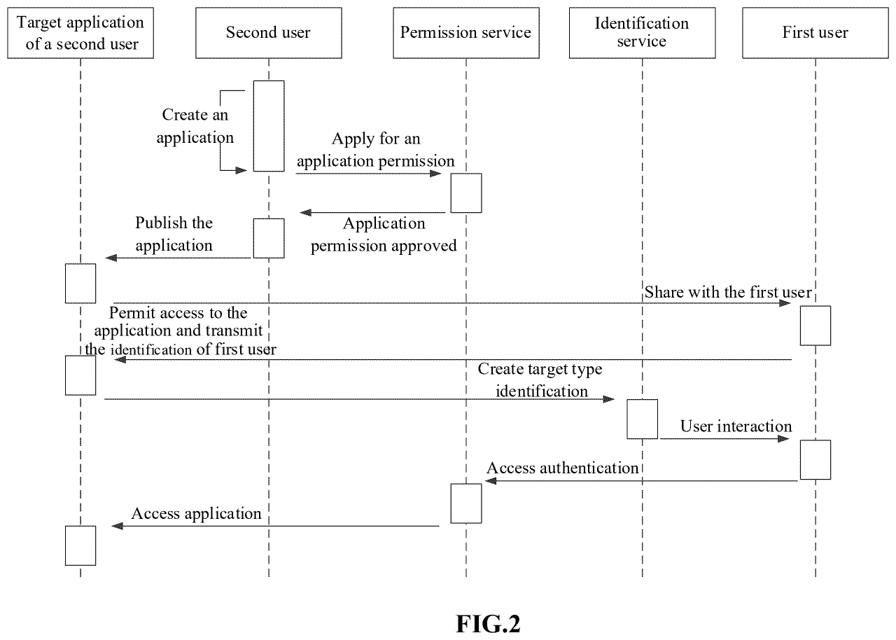

In some embodiments of the present disclosure, a specific embodiment is proposed with reference to FIG. 2. In FIG. 2, the second user first creates an application (the application is only an example, and the type of the target resource is not limited) as the target resource, and then applies for an application permission (that is, the first user's access permission to the application). After the application permission is approved, the second user may publish the application to a resource sharing platform, so that users in the second user group can use the application (the identifications of the users in the second user group may be added to the identification list by default). The application in the resource sharing platform may be shared with the first user by means of links and the like, and the first user may trigger the access to the target resource by means of clicking on links and the like. At this time, it is determined that the first user has the access permission to the target resource, and the identification of the first user is acquired and transmitted to the application. If the application checks and determines that the identification of the first user is not in the associated identification list (because the first user is not a user in the second user group, and the identification of the first user is not in the identification list), the identification service will be invoked to create the target type identification for the first user. The target type identification is mapped to an identification of the second user and a resource identification of the application. After creating the target type identification, a user interaction (such as a reminder or a message) is sent to the first user, and then the first user can access the application by means of refreshing the page and the like. When the first user accesses the application, further authentication will be performed to determine that the first user has the access permission to the target content to be accessed, and the access can be performed after the authentication is successful.

In some embodiments of the present disclosure, the target type identification is created for the first user without perception, and the target resource is shared without breaking the user group isolation. The method may be used in a scenario of upstream and downstream collaboration of enterprises, and the first user and the second user may be users belonging to upstream and downstream enterprises respectively, and the upstream and downstream enterprises are different user groups. For example, an enterprise is the second user group, employees in the enterprise are the second user, external suppliers of the enterprise may be the first user group, and employees of the suppliers are the first user. Through some embodiments of the present disclosure, external suppliers can conveniently access and use the target resource (such as a collaborative application) of the enterprise without additional registration and switching of user groups, and can effectively integrate with the enterprise's business processes, thereby improving efficiency. In addition, it can help enterprises to spread applications and improve efficiency.

The present disclosure further provides a resource sharing apparatus, including:
an acquiring unit, configured to acquire, in response to a first operation of a first user accessing a target resource and the first user having an access permission to the target resource, an identification of the first user, where the first user belongs to a first user group, and the target resource belongs to a second user group to which a second user belongs; and
a control unit, configured to create, in response to an identification list associated with the target resource not including the identification of the first user, a target type identification for the first user and add the target type identification to the identification list;
where the identification list is used to record an identification of user who is able to access the target resource.

In some embodiments, the first user is only able to access resources of the first user group through the identification of the first user.

In some embodiments, the target resource includes an application; and/or, the target resource is a resource created by the second user.

In some embodiments, the control unit is further configured to, after creating the target type identification for the first user and adding the target type identification to the identification list, access the target resource through the target type identification.

In some embodiments, accessing the target resource through the target type identification includes: determining the first user's permission for a target content in the target resource in response to the first user accessing the target content; and determining whether to display the target content for the first user based on whether the first user has an access permission to the target content.

In some embodiments, the target type identification is mapped to an identification of the second user and a resource identification of the target resource respectively.

In some embodiments, the control unit is further configured to, before acquiring, in response to the first operation of the first user accessing the target resource, the identification of the first user, grant the first user the access permission to the target resource in response to a second operation of the second user; and/or, the control unit is further configured to, before acquiring, in response to the first operation of the first user accessing the target resource, the identification of the first user, share the target resource with the first user in response to a third operation on the target resource.

For the apparatus embodiments, since they basically correspond to the method embodiments, reference may be made to the partial description of the method embodiments for relevant parts. The apparatus embodiments described above are only illustrative, and the modules described as separate modules may or may not be separate. Some or all of the modules may be selected according to actual needs to achieve the purpose of the solutions of the embodiments. Those skilled in the art can understand and implement without paying creative labor.

Above, the method and apparatus of the present disclosure are described based on embodiments and application examples. In addition, the present disclosure further provides an electronic device and a computer-readable storage medium, which will be described below.

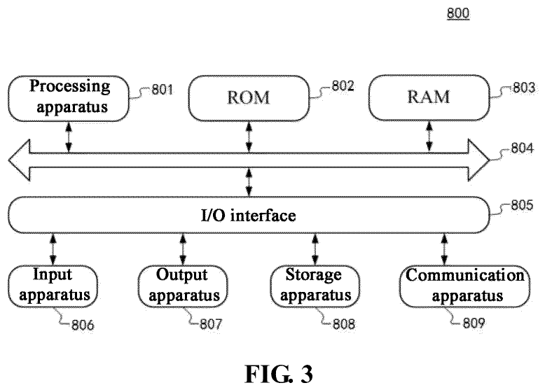

Reference is made to FIG. 3 below, which illustrates a schematic structural diagram of an electronic device (such as a terminal device or a server) 800 suitable for implementing the embodiments of the present disclosure. The terminal device in the embodiment of the present disclosure may include, but is not limited to, a mobile terminal such as a mobile phone, a notebook computer, a digital broadcast receiver, a PDA (Personal Digital Assistant), a tablet computer, a PMP (Portable Multimedia Player), a vehicle-mounted terminal (such as a vehicle-mounted navigation terminal), and a fixed terminal such as a digital TV, a desktop computer, and the like. The electronic device shown in the figure is only an example, and should not impose any limitation on the function and usage scope of the embodiments of the present disclosure.

The electronic device 800 may include a processing apparatus (such as a central processing unit, a graphics processing unit, etc.) 801, which can execute various appropriate actions and processing according to a program stored in a read-only memory (ROM) 802 or a program loaded from a storage device 808 into a random access memory (RAM) 803. Various programs and data required for the operation of the electronic device 800 are also stored in the RAM 803. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806, including, for example, a touchscreen, a touchpad, a keyboard, a mouse, a camera, a microphone, an accelerometer, a gyroscope, etc.; an output apparatus 807, including, for example, a liquid crystal display (LCD), a speaker, a vibrator, etc.; a storage apparatus 808, including, for example, a magnetic tape, a hard disk, etc.; and a communication apparatus 809. The communication apparatus 809 may allow the electronic device 800 to perform wireless or wired communication with other devices to exchange data. Although the electronic device 800 with various apparatuses is shown in the figure, it should be understood that not all of the apparatuses shown here need to be implemented or provided. Alternatively, more or fewer apparatuses may be implemented or provided.

In particular, according to the embodiments of the present disclosure, the process described above with reference to the flowcharts may be implemented as a computer software program. For example, an embodiment of the present disclosure includes a computer program product, which includes a computer program carried on a computer-readable medium, and the computer program includes program codes for executing the method shown in the flowcharts. In such an embodiment, the computer program may be downloaded and installed from a network through the communication apparatus 809, or installed from the storage apparatus 808, or installed from the ROM 802. When the computer program is executed by the processing apparatus 801, the above functions defined in the methods of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium including or storing a program, and the program may be used by or in combination with an instruction execution system, apparatus, or device. In the present disclosure, the computer-readable signal medium may include a data signal propagated in a baseband or as a part of a carrier wave, and computer-readable program codes are carried in the data signal. The data signal propagated in this manner may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes included on the computer-readable medium may be transmitted by any suitable medium, including but not limited to an electrical wire, an optical cable, a radio frequency (RF), etc., or any suitable combination thereof.

In some implementations, clients and servers may communicate using any currently known or future developed network protocol such as Hyper Text Transfer Protocol (HTTP), and may be interconnected with digital data communication (for example, a communication network) in any form or medium. Examples of the communication network include a local area network (“LAN”), a wide area network (“WAN”), an internet (for example, the Internet), and a peer-to-peer network (for example, an ad hoc network), as well as any currently known or future developed network.

The above computer-readable medium may be included in the above electronic device; or may also exist alone without being assembled into the electronic device.

The above computer-readable medium carries one or more programs, and when the one or more programs are executed by the electronic device, the electronic device is caused to execute the above method of the present disclosure.

The computer program codes for executing the operations of the present disclosure may be written in one or more programming languages or a combination thereof, where the above programming languages include object-oriented programming languages such as Java, Smalltalk, C++, and also include conventional procedural programming languages such as “C” language or similar programming languages. The program codes may be executed entirely on a user's computer, partly on a user's computer, as a stand-alone software package, partly on a user's computer and partly on a remote computer, or entirely on a remote computer or server. In the case of involving the remote computer, the remote computer may be connected to the user's computer through any kind of network, including a local area network (LAN) or a wide area network (WAN), or may be connected to an external computer (for example, connected through the Internet using an Internet service provider).

The flowcharts and block diagrams in the drawings illustrate possible architecture, functions and operations of the system, method and computer program product according to various embodiments of the present disclosure. In this regard, each block in the flowchart or block diagram may represent a module, a program segment, or a part of codes, and the module, program segment, or part of codes contains one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a special purpose hardware-based system that performs the specified functions or operations, or may also be implemented by a combination of special purpose hardware and computer instructions.

The units involved in the embodiments described in the present disclosure may be implemented by software or hardware. The name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the foregoing. More specific examples of the machine-readable storage medium may include an electrical connection having one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

According to one or more embodiments of the present disclosure, a resource sharing method is provided, including:
acquiring, in response to a first operation of a first user accessing a target resource, an identification of the first user, where the first user is granted an access permission to the target resource by a second user, the first user belongs to a first user group, and the target resource belongs to a second user group to which the second user belongs; and
creating, in response to an identification list associated with the target resource not including the identification of the first user, a target type identification for the first user and adding the target type identification to the identification list;
where the identification list is used to record an identification of user who is able to access the target resource.

According to one or more embodiments of the present disclosure, a resource sharing method is provided, where the first user is only able to access resources of the first user group through the identification of the first user.

According to one or more embodiments of the present disclosure, a resource sharing method is provided, where the target resource includes an application; and/or, the target resource is a resource created by the second user.

According to one or more embodiments of the present disclosure, a resource sharing method is provided, where after creating the target type identification for the first user and adding the target type identification to the identification list, the method further includes:
accessing the target resource through the target type identification.

According to one or more embodiments of the present disclosure, a resource sharing method is provided, where accessing the target resource through the target type identification includes:
determining the first user's permission for a target content in the target resource in response to the first user accessing the target content; and
determining whether to display the target content for the first user based on whether the first user has an access permission to the target content.

According to one or more embodiments of the present disclosure, a resource sharing method is provided, where the target type identification is mapped to an identification of the second user and a resource identification of the target resource respectively.

According to one or more embodiments of the present disclosure, a resource sharing method is provided, where before acquiring, in response to the first operation of the first user accessing the target resource, the identification of the first user, the method further includes:
granting the first user the access permission to the target resource in response to a second operation of the second user; and
sharing the target resource with the first user in response to a third operation on the target resource.

According to one or more embodiments of the present disclosure, a resource sharing apparatus is provided, including:
an acquiring unit, configured to acquire, in response to a first operation of a first user accessing a target resource, an identification of the first user, where the first user is granted an access permission to the target resource by a second user, the first user belongs to a first user group, and the target resource belongs to a second user group to which the second user belongs; and
a control unit, configured to create, in response to an identification list associated with the target resource not including the identification of the first user, a target type identification for the first user and add the target type identification to an identification list;
where the identification list is used to record an identification of user who is able to access the target resource.

According to one or more embodiments of the present disclosure, an electronic device is provided, including: at least one memory and at least one processor;
where the at least one memory is configured to store program codes, and the at least one processor is configured to invoke the program codes stored in the at least one memory to perform the method according to any one of the above.

According to one or more embodiments of the present disclosure, a computer-readable storage medium is provided, where the computer-readable storage medium is used to store program codes, and the program codes, when run by a processor, prompt the processor to execute the above method.

The above description is only preferred embodiments of the present disclosure and an illustration of the applied technical principles. Those skilled in the art should understand that the disclosure scope involved in the present disclosure is not limited to the technical solutions formed by the specific combination of the above technical features, and should also cover other technical solutions formed by any combination of the above technical features or equivalent features thereof without departing from the above disclosed concept. For example, a technical solution formed by replacing the above features with technical features with similar functions disclosed in the present disclosure (but not limited to).

In addition, although operations are depicted in a particular order, it should not be understood as requiring these operations to be performed in a particular order as shown or in a sequential order. Under certain circumstances, multitasking and parallel processing may be advantageous. Likewise, although the above discussion contains several specific implementation details, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are only example forms for implementing the claims.

I/We claim:

1. A resource sharing method, comprising:
acquiring, in response to a first operation of a first user accessing a first resource and the first user having an access permission to the first resource, an identification of the first user, wherein the first user belongs to a first user group, and the first resource belongs to a second user group to which a second user belongs; and
creating, in response to an identification list associated with the first resource not comprising the identification of the first user, a first type identification for the first user and adding the first type identification to the identification list;
wherein the identification list is used to record an identification of user who is able to access the first resource.

2. The method of claim 1, wherein the first user is only able to access resources of the first user group through the identification of the first user.

3. The method of claim 1, wherein the first resource comprises an application; and/or, the first resource is a resource created by the second user.

4. The method of claim 1, wherein after creating the first type identification for the first user and adding the first type identification to the identification list, the method further comprises:
accessing the first resource through the first type identification.

5. The method of claim 4, wherein the accessing the first resource through the first type identification comprises:
determining the first user's permission for a first content in the first resource in response to the first user accessing the first content; and
determining whether to display the first content for the first user based on whether the first user has an access permission to the first content.

6. The method of claim 1, wherein the first type identification is mapped to an identification of the second user and a resource identification of the first resource respectively.

7. The method of claim 1, wherein before acquiring, in response to the first operation of the first user accessing the first resource, the identification of the first user, the method further comprises:
granting the first user the access permission to the first resource in response to a second operation of the second user; and/or,
sharing the first resource with the first user in response to a third operation on the first resource.

8. An electronic device, comprising:
at least one memory and at least one processor;
wherein the at least one memory is configured to store program codes, and the program codes, when invoked by the at least one processor, cause the at least one processor to:
acquire, in response to a first operation of a first user accessing a first resource and the first user having an access permission to the first resource, an identification of the first user, wherein the first user belongs to a first user group, and the first resource belongs to a second user group to which a second user belongs; and
create, in response to an identification list associated with the first resource not comprising the identification of the first user, a first type identification for the first user and add the first type identification to the identification list;
wherein the identification list is used to record an identification of user who is able to access the first resource.

9. The electronic device of claim 8, wherein the first user is only able to access resources of the first user group through the identification of the first user.

10. The electronic device of claim 8, wherein the first resource comprises an application; and/or, the first resource is a resource created by the second user.

11. The electronic device of claim 8, wherein the program codes further cause the at least one processor to:
access the first resource through the first type identification.

12. The electronic device of claim 11, wherein the program codes further cause the at least one processor to:
determine the first user's permission for a first content in the first resource in response to the first user accessing the first content; and
determine whether to display the first content for the first user based on whether the first user has an access permission to the first content.

13. The electronic device of claim 8, wherein the first type identification is mapped to an identification of the second user and a resource identification of the first resource respectively.

14. The electronic device of claim 8, wherein the program codes further cause the at least one processor to:
grant the first user the access permission to the first resource in response to a second operation of the second user; and/or,
share the first resource with the first user in response to a third operation on the first resource.

15. A non-transitory computer-readable storage medium, wherein the computer-readable storage medium is used to store program codes, and the program codes, when executed by a processor, cause the processor to:
acquire, in response to a first operation of a first user accessing a first resource and the first user having an access permission to the first resource, an identification of the first user, wherein the first user belongs to a first user group, and the first resource belongs to a second user group to which a second user belongs; and
create, in response to an identification list associated with the first resource not comprising the identification of the first user, a first type identification for the first user and add the first type identification to the identification list;
wherein the identification list is used to record an identification of user who is able to access the first resource.

16. The non-transitory computer-readable storage medium of claim 15, wherein the first user is only able to access resources of the first user group through the identification of the first user.

17. The non-transitory computer-readable storage medium of claim 15, wherein the first resource comprises an application; and/or, the first resource is a resource created by the second user.

18. The non-transitory computer-readable storage medium of claim 15, wherein the program codes further cause the processor to:
access the first resource through the first type identification.

19. The non-transitory computer-readable storage medium of claim 18, wherein the program codes further cause the processor to:
determine the first user's permission for a first content in the first resource in response to the first user accessing the first content; and
determine whether to display the first content for the first user based on whether the first user has an access permission to the first content.

20. The non-transitory computer-readable storage medium of claim 15, wherein the first type identification is mapped to an identification of the second user and a resource identification of the first resource respectively.
